(19) United States
(12) Patent Application Publication
(10) Pub. No.: US 2008/0318618 A1
(43) Pub. Date: Dec. 25, 2008

(54) MOBILE COMMUNICATION DEVICE AND METHOD OF CONTROLLING THE SAME

(75) Inventor: So Young PARK, Seoul (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/142,560

(22) Filed: Jun. 19, 2008

(30) Foreign Application Priority Data
Jun. 20, 2007 (KR) 10-2007-0060671

(51) Int. Cl. H04M 1/00; G06F 3/02

(52) U.S. Cl. 455/550.1; 345/169

(57) ABSTRACT

The present invention relates to mobile communication devices and a method of controlling the same. The mobile communication device includes a plurality of keys for entering different commands in first and second operating modes, memory for storing key mapping information in which commands corresponding to respective inputs of the plurality of keys are mapped every operating modes, and a mode switch detection unit for determining whether to switch an operating mode from the first operating mode to the second operating mode. When the operating mode is switched, a controller controls some of the plurality of keys to switch to key mapping information used in the second operating mode and the remaining keys to maintain key mapping information used in the first operating mode, based on the key mapping information.

### CROSS-REFERENCE TO RELATED APPLICATION

This application claims the benefit of Korean Application No. 2007-0060671, filed Jun. 20, 2007 in the Korean Intellectual Property Office, the disclosure of which is incorporated herein by reference.

### BACKGROUND OF THE INVENTION

1. Field of the Invention

The present invention relates to mobile communication devices and a method of controlling the same in which a command mapped to a key used for input is adaptively switched according to an operating mode.

2. Description of the Related Art

With the improved performance of mobile communication devices and the advent of various mobile platforms, mobile communication devices could become able to perform a variety of supplementary functions other than the basic functions such as voice call or Short Message Service (SMS). In particular, as mobile communication devices supporting wireless Internet, multimedia function, etc. are commercialized, the mobile communication devices have become more advanced and multi-functional.

In line with this trend, mobile communication devices, having a multi-tasking function capable of employing various supplementary functions at the same time, have also been developed. Mobile communication devices with this multi-tasking function enable users to execute several tasks at the same time, such as sending messages while listening to music or playing game while downloading data. In other words, in mobile communication devices enabling this multi-tasking function, two or more tasks can be processed at the same time or two or more programs can be executed at the same time.

Regarding a key included in a mobile communication device having the multi-tasking function, in the case in which the function of the key is fully changed according to its operating mode or a corresponding key is set to a hard key, key mapping is generally configured to execute always the same function irrespective of an operating mode. Accordingly, in order to use various supplementary functions included in mobile communication devices or execute several tasks at the same time through multi-tasking by employing this key mapping configuration, complicated manipulation of the key, such as movement of menus, etc., is required. Accordingly, there is a need for a method of controlling the operation of mobile communication devices more efficiently through alternative methods other than this key mapping configuration.

### SUMMARY OF THE INVENTION

Accordingly, the present invention is directed to provide a mobile communication device and a method of controlling the same, in which a command mapped to a key used for input is adaptively switched according to an operating mode.

A mobile communication device in accordance with an aspect of the present invention includes a plurality of keys for entering different commands in first and second operating modes, memory for storing key mapping information in which commands corresponding to respective inputs of the plurality of keys are mapped every operating modes, a mode switch detection unit for determining whether to switch an operating mode from the first operating mode to the second operating mode, and a controller for, when the operating mode is switched, controlling some of the plurality of keys to switch to key mapping information used in the second operating mode and the remaining keys to maintain key mapping information used in the first operating mode, based on the key mapping information.

A method of controlling a mobile communication device in accordance with an aspect of the present invention includes the steps of providing a plurality of keys for entering different commands in first and second operating modes and storing key mapping information in which commands corresponding to respective inputs of the plurality of keys are mapped every operating modes, determining whether an operating mode has switched from the first operating mode to the second operating mode, and if, as a result of the determination, the operating mode has switched from the first operating mode to the second operating mode, controlling some of the plurality of keys to switch to key mapping information used in the second operating mode and the remaining keys to maintain key mapping information used in the first operating mode, based on the key mapping information.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIGS. 1 and 2 are diagrams showing the external appearance of a mobile communication device in accordance with an embodiment of the present invention;

FIG. 3 is a block diagram of the mobile communication device in accordance with an embodiment of the present invention;

FIGS. 4A to 4C are flowcharts illustrating a method of controlling the mobile communication device in accordance with an embodiment of the present invention;

FIGS. 5 to 7 are diagrams to which reference is made so as to describe the method of controlling the mobile communication device in accordance with an embodiment of the present invention along with a music play mode screen; and

FIGS. 8 to 10 are diagrams to which reference is made so as to describe the method of controlling the mobile communication device in accordance with an embodiment of the present invention along with a multi-tasking screen.

### DETAILED DESCRIPTION OF THE INVENTION

The present invention will now be described in detail in connection with specific embodiments with reference to the accompanying drawings.

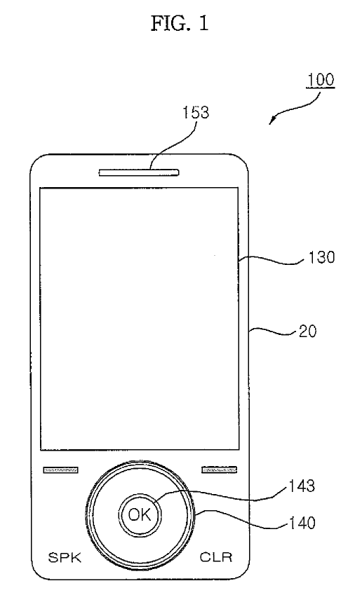

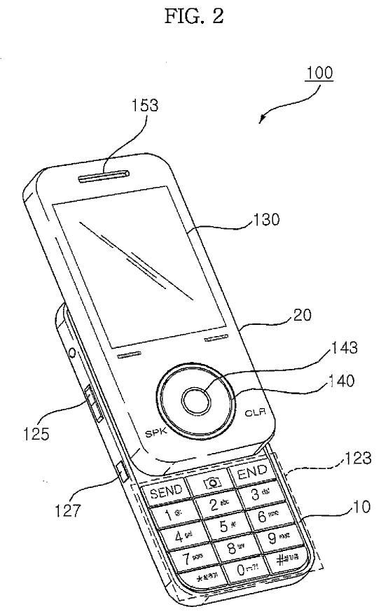

FIGS. 1 and 2 are diagrams showing the external appearance of a mobile communication device in accordance with an embodiment of the present invention. Referring to FIGS. 1 and 2.

The mobile communication device 100 in accordance with an embodiment of the present invention includes a main body 10, and a cover 20 coupled to the main body 10 in a sliding manner such as sliding-up or sliding-down. The cover 20 is equipped with a display unit 130, such as a Liquid Crystal Display (LCD), and an enter key 140 enabling a rotating enter, such as a wheel key. The enter key 140 has a button 143, allowing for a press enter, disposed at its center, and therefore allows for the press enter as well as the rotating enter.

The main body 10 is equipped with a keypad 123. Accordingly, in the state in which the cover 20 slides up, a telephone number for a call, a user's operating command or command, and so on can be entered through the keypad 123. A volume control key 125 for controlling the sound volume and a hot key 127 for operating a camera function are disposed on the side of the main body 10.

Meanwhile, although, in FIGS. 1 and 2, the wheel key has been illustrated as the enter key 140, a key, such as a touch pad, a track ball or a pointing stick, may also be used as the enter key 140.

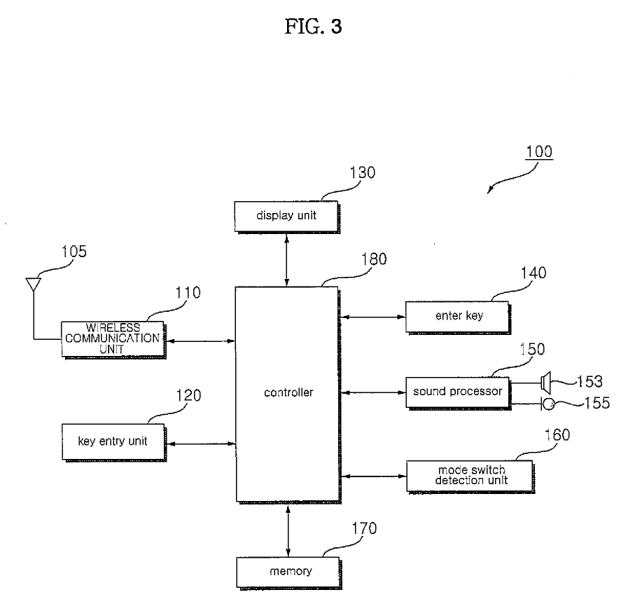

FIG. 3 is a block diagram of the mobile communication device in accordance with an embodiment of the present invention. Referring to FIG. 3, the mobile communication device 100 of the present embodiment includes a wireless communication unit 110, a key entry unit 120, a display unit 130, an enter key 140, a sound processor 150, a mode switch detection unit 160, memory 170, and a controller 180. Here, when the above constituent elements are implemented in actual applications, two or more of the constituent elements may be combined into one constituent element, or one constituent element may be divided into two or more constituent elements, if appropriate.

The wireless communication unit 110 provides an interface for radio communication with a base station through an antenna 105, and includes a duplex filter for filtering transmit/receive signals to/from the antenna, a power amplifier for amplifying a transmit signal, a frequency uplink converter of a transmission route, a frequency downlink converter of a reception route, and so on.

The key entry unit 120 includes the keypad 123 having numeric keys and function keys, the volume control key 125, etc. The key entry unit 120 transfers a signal, corresponding to a key pressed by a user, to the controller 180 and receives a user's operating command or data, a user-selected command for setting a specific function, and so on. The display unit 130 displays menus for operation control, a signal receive status, battery information, information about the operating status of a mobile communication device according to a command input by a user, and the like.

The enter key 140 is a key enabling a rotating enter, such as the wheel key. When operating, the enter key 140 can output signals, indicating a rotating direction, a rotating degree, etc. The enter key 140 can also output a signal corresponding to the press enter in a vertical direction. The enter key 140 transfers a signal, corresponding to a rotating direction, a rotating degree or the press enter, to the controller 180 and receives a user's operating command, etc.

The sound processor 150 amplifies a sound signal output from the controller 180 and outputs the amplified signal to the speaker 153 or the like, or converts a sound signal, input through a microphone (not shown) or the like, into an electrical signal and transfers the converted signal to the controller 180. In particular, the sound processor 150 can play a selected music file from music files stored in the memory 170 under the control of the controller 180.

When there is no input through the key entry unit 120 or the enter key 140 for a specific time period, a key set to mode switching is pressed or the like, the mode switch detection unit 160 transmits a mode switch signal, indicating that an operating mode has been switched, to the controller 180. The mode switch detection unit 160 can include a sensor for sensing the position of the cover 20 and therefore transmit a detection signal, indicating whether the cover 20 is in a slide-up state or a slide-down state, to the controller 180 in order to indicate that an operating mode has been switched.

The memory 170 can include ROM, RAM, flash memory or the like, and store programs or data necessary to operate a mobile communication device, various data to be stored by a user, playable music files, and so on. The memory 170 can also store contents set according to a user's command input through the key entry unit 120. The memory 170 can also store key mapping information in which commands, each corresponding to the inputs of a plurality of keys, included in the key entry unit 120 and the enter key 140, are mapped every operating mode. Alternatively, such key mapping information may not be stored in the additional memory 170, but in the controller 180 depending on use environment.

The controller 180 controls an overall operation of the mobile communication device by controlling the operation of each of the elements. In particular, when it is determined that an operating mode has switched from a first operating mode to a second operating mode based on the mode switch signal output through the mode switch detection unit 160, the controller 180 can control some of the plurality of keys, included in the key entry unit 120 and the enter key 140, to switch to key mapping information used in the second operating mode, and control the remaining keys the plurality of keys to maintain key mapping information used in the first operating mode. Accordingly, the functions of the plurality of keys can change adaptively according to operating modes.

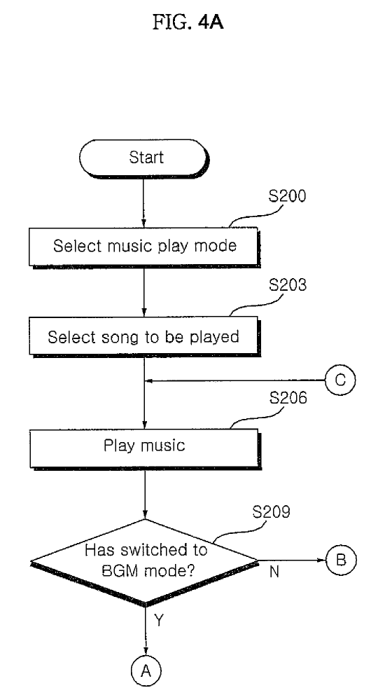

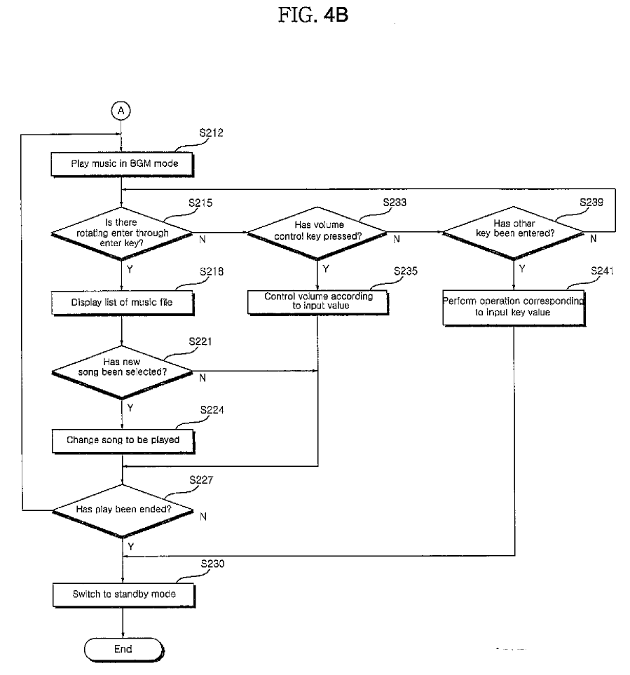

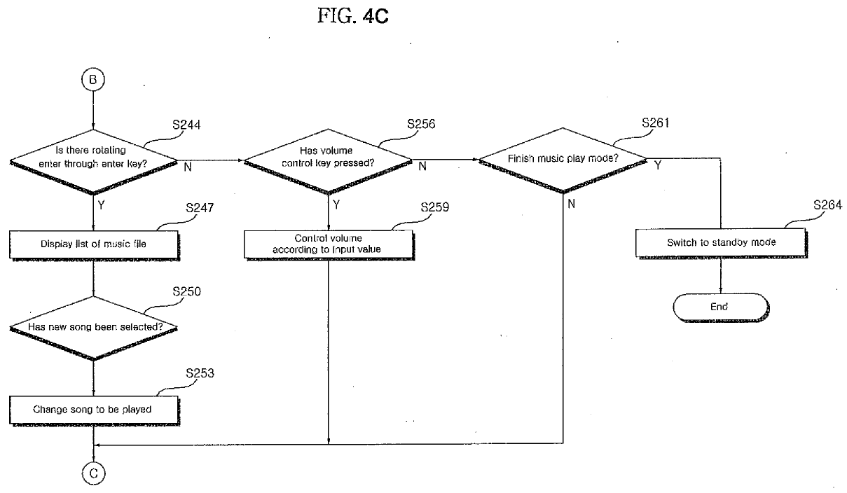

FIGS. 4A to 4C are flowcharts illustrating a method of controlling the mobile communication device in accordance with an embodiment of the present invention. Referring first to FIG. 4A, when a music play mode is selected through menu selection, etc, in step in step S200, the controller 180 displays a list of playable files on the display unit 130 so that song to be played can be selected in step S203. If song to be played is selected, the controller 180 controls the sound processor 150 to play the selected music in step S206.

In the case in which there is a key input signal to switch to a Background Music (BGM) mode during the music play or there is nothing key input for a specific time period according to set items, or in the case in which the music play switches to the BGM mode since the cover 20 slides down, etc. in step S209, the controller 180 controls the music to be played in the BGM mode in step S212, as shown in FIG. 4B.

The BGM mode is a kind of the multi-tasking function. If the BGM function is used, text messages can be sent or received or menus, etc. can be employed, while playing music files. In the case of a folder type mobile communication device, the mobile communication device may be configured to switch to the BGM multi-tasking mode when the folder is closed.

In this BGM multi-tasking mode, when there is a rotating enter through the wheel key, etc., which is used as the enter key 140, the controller 180 controls a list of playable music files, to be displayed on the display unit 130 in step S218. The enter key 140 performs a function of scrolling menu items through the rotating enter in an idle mode, etc.

If a new song is selected from the displayed list in step S221, the controller 180 changes song to be played in step S224. In this case, a desired song may be selected by scrolling items displayed on the list according to the rotation of the enter key 140 and pressing the button at the center of the enter key 140. If the end of the music play is not selected after the music play is finished, the controller 18 can control music to be played in the BGM mode in step S227, in step S212.

If, in step S215, there is no rotating enter through the enter key 140, but the volume control key is pressed in step S233, the controller 180 controls the volume of a music file, which is being played, to be adjusted according to a value input through the volume control key in step S235. In the case in which a key other than the enter key or the volume control key is pressed in step S239, the controller 180 can control an operation corresponding to a command, which is mapped to the pressed key, to be performed in step S241.

In the case in which the BGM mode is not selected during the music play mode in step S209, if there is rotating enter through the wheel key, etc., which is used as the enter key 140 in step S244, the controller 180 displays a list of playable music files in step S247, as shown in FIG. 4C. If a new song is selected from the displayed list in step S250, the controller 180 changes song to be played and controls a selected song to play in step S253. If there is no rotating enter in step S244, but the volume control key is pressed in step S256, the controller 180 controls the volume of a music file that is now being played according to an input value in step S259. If the end of the music play mode is selected in step S261, the controller 180 controls the mode to switch to a standby mode in step S264.

Through this process, the enter key 140 can perform not only the scrolling function of menu items, list items, etc., which are displayed in an idle mode, etc., but also functions pertinent to the play of music, such as displaying a list of music files, in the music play mode or the BGM multi-tasking mode.

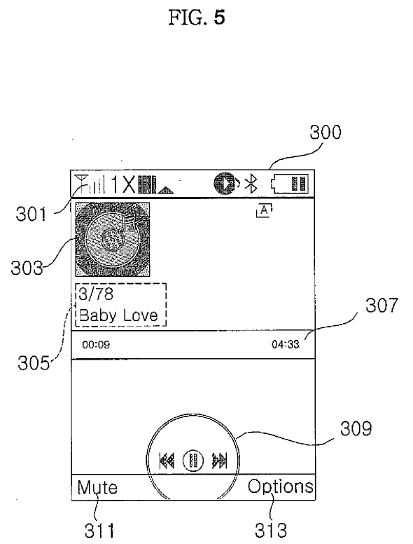

FIGS. 5 to 7 are diagrams to which reference is made so as to describe the method of controlling the mobile communication device in accordance with an embodiment of the present invention along with a music play mode screen.

First, FIG. 5 shows an example of a music play mode screen 300, which is displayed on the display unit 130 when the music play mode is selected. Referring to FIG. 5, an indicator icon 301 is displayed at the top of the music play mode screen 300. An icon 303, indicating that a current operating mode is the music play mode, is displayed under the indicator icon 301. Further, a song title 305 that is now being played, and a total play time and a progress time 307 are displayed on the middle side of the music play mode screen 300. An icon 309, indicating a function corresponding to the wheel key, is displayed on a lower side of the music play mode screen 300. Menu items, such as ‘Mute’ 131 for temporarily shutting a sound output and ‘Options’ 313 for selecting options during play, are displayed at the bottom of the music play mode screen 300.

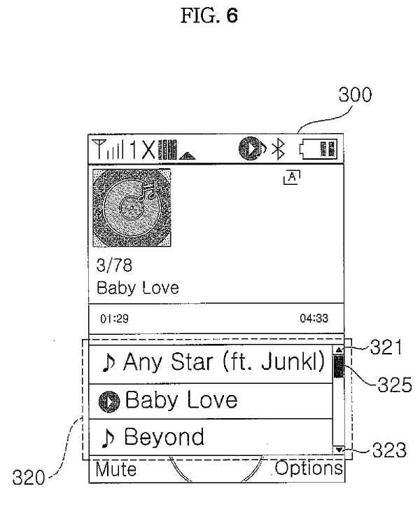

In the state in which this music play mode screen 300 is displayed, if there is rotating enter through the wheel key, a list 320 of playable music files is displayed as shown in FIG. 6. The list 320 displays playable music files on the basis of a music file that is now being played. A vertical scroll bar 325 and scroll arrows 321 and 323 for scrolling items displayed in the list in the up and down directions are displayed on the left of the list 320.

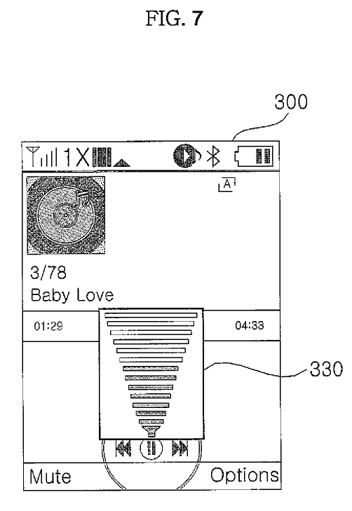

FIG. 7 shows that a menu 300 for controlling the volume of a music file, now being played, is displayed when the volume control key is pressed in the music play mode screen 300. The volume of a music file now being played is controlled according to a value input through the volume control key.

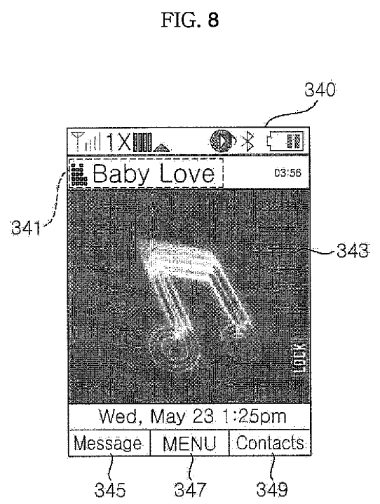

FIG. 8 shows an example of a BGM screen 340 displayed when the BGM multi-tasking mode is selected. If the BGM select key is pressed, there is no key input for a specific time period or the like in the music play mode, a mode switches to the BGM multi-tasking mode. The BGM screen 340 displays a title 341 of a music file, which is now being played as background, and a background screen 343 indicating that a music file is now being played as background.

Menu items, such as ‘Message’ 345 for message transmission, ‘MENU’ 347 for selecting menus, and ‘Contacts’ 349, are displayed at the bottom of the BGM screen 340.

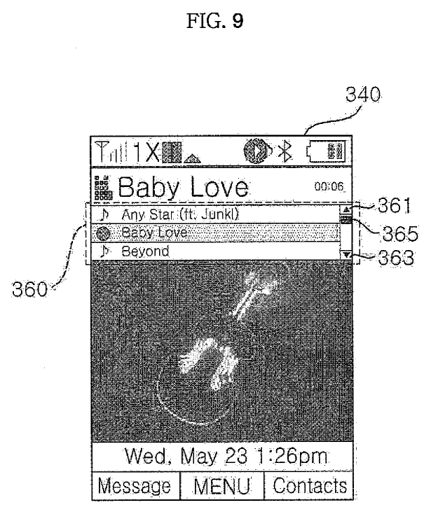

If there is rotating enter through the wheel key, etc., which is used as the enter key even in this BGM screen 340, a list 360 of playable music files is displayed, as shown in FIG. 9. Here, the displayed list 360 is a list of playable music files, including song that is now being played. A vertical scroll bar 365 and scroll arrows 361, 363 for scrolling items displayed in the list 360 in the up and down directions are displayed on the left of the list 360. Scrolling of the items displayed in the list 360 can be performed by the rotating enter of the enter key or other keys.

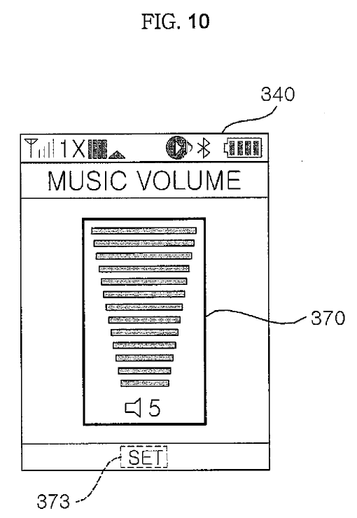

FIG. 10 shows that a menu 370 for controlling the volume of a music file, which is now being played, is displayed when the volume control key is pressed in the BGM screen 340. The volume of a music file, which is now being played, is controlled according to a value input through the volume control switch.

Some keys may have its key mapping switched in such a way as to be suitable for a switched mode and some keys may not have its key mapping switched, but keep remains according to this switching of the operating mode, so that the mobile communication device can be controlled efficiently.

In the above embodiments, the music play mode and the BGM multi-tasking mode have been described as examples. It is, however, to be understood that the mobile communication device and the method of controlling the same in accordance with the present invention are not limited to the operating modes, but can be applied to a variety of operating modes, which can be operated in other mobile communication devices.

Meanwhile, the present invention can be implemented as a processor-readable code in a recording medium, which can be read by a processor included in mobile communication devices. The processor-readable recording medium can include all kinds of recording devices in which data readable by a processor is stored. For example, the processor-readable recording medium can include ROM, RAM, CD-ROM, magnetic tapes, floppy disks, optical data storages, and so on, and can also be implemented in the form of carrier waves, such as transmission over an Internet. The processor-readable recording medium can also be distributed into computer systems connected over a network, and codes readable by a processor can be stored and executed in a distributed manner.

As described above, according to the present invention, a command mapped to a key used for input, etc. adaptively switches according to an operating mode. Accordingly, the operation of a mobile communication device can be controlled efficiently. In particular, the enter key can be made to executed other functions by changing a command mapped according to operating mode. Accordingly, the basic call function can be performed or tasks, which are being executed through multi-tasking, in the multi-tasking mode can be controlled efficiently.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile communication device, comprising:
a plurality of keys configured to enter different commands in first and second operating modes;
memory configured to store key mapping information in which commands corresponding to respective inputs of the plurality of keys are mapped every operating modes;
a mode switch detection unit configured to determine whether to switch an operating mode from the first operating mode to the second operating mode; and
a controller configured to, when the operating mode is switched, control some of the plurality of keys to switch to key mapping information used in the second operating mode and the remaining keys to maintain key mapping information used in the first operating mode, based on the key mapping information.

2. The mobile communication device of claim 1, wherein:
the first operating mode comprises an idle mode, and
the second operating mode comprises a multi-tasking mode.

3. The mobile communication device of claim 1, wherein:
the first operating mode comprises a music play mode, and
the second operating mode comprises a multi-tasking mode.

4. The mobile communication device of claim 1, wherein the mode switch detection unit determines to switch the operating mode either when there is no input from the plurality of keys for a specific time period or when a key to switch to the second operating mode is pressed.

5. The mobile communication device of claim 1, wherein the second operating mode comprises a Back Background Music (BGM) multi-tasking mode.

6. The mobile communication device of claim 5, wherein the controller controls either message transmission or a call to be executed when a specific key is pressed in the BGM multi-tasking mode.

7. The mobile communication device of claim 5, wherein the controller controls a menu for controlling a volume of a music file, which is being played, to be displayed when a specific key is pressed in the BGM multi-tasking mode.

8. The mobile communication device of claim 5, wherein the some keys comprise keys for displaying a list of playable music files and scrolling items displayed in the list.

9. The mobile communication device of claim 8, further comprising a display unit,
wherein the controller displays a preset background screen on the display unit when the operating mode switches to the second operating mode, and controls an icon, which corresponds to a multi-tasking task that is now being executed, to be displayed in one area of the background screen.

10. The mobile communication device of claim 9, wherein:
the some keys comprise a wheel key, and
the controller controls the list to be displayed when there is rotating enter through the wheel key.

11. The mobile communication device of claim 10, wherein the controller controls items displayed in the list to be scrolled when there is rotating enter through the wheel key.

12. A method of controlling a mobile communication device, the method comprising:
providing a plurality of keys for entering different commands in first and second operating modes and storing key mapping information in which commands corresponding to respective inputs of the plurality of keys are mapped every operating modes;
determining whether an operating mode has switched from the first operating mode to the second operating mode; and
if, as a result of the determination, the operating mode has switched from the first operating mode to the second operating mode, controlling some of the plurality of keys to switch to key mapping information used in the second operating mode and the remaining keys to maintain key mapping information used in the first operating mode, based on the key mapping information.

13. The method of claim 12, wherein:
the first operating mode comprises an idle mode, and
the second operating mode comprises a multi-tasking mode.

14. The method of claim 12, wherein:
the first operating mode comprises a music play mode, and
the second operating mode comprises a multi-tasking mode.

15. The method of claim 12, wherein the determination step comprises determining that the operating mode has been switched either when there is no input from the plurality of keys for a specific time period or when a key to switch to the second operating mode is pressed.

16. The method of claim 12, wherein the second operating mode comprises a BGM multi-tasking mode.

17. The method of claim 16, wherein the some keys comprise keys for displaying a list of playable music files and scrolling items displayed in the list.

18. The method of claim 17, further comprising the step of, when the operating mode switches to the second operating mode, displaying a preset background screen, and displaying an icon, which corresponds to a multi-tasking task that is now being executed, in one area of the background screen.

19. The method of claim 16, wherein:
the some keys comprise a wheel key, and
when there is rotating enter through the wheel key, the list is displayed.

20. The method of claim 19, further comprising the step of, when there is rotating enter through the wheel key, scrolling items displayed in the list.

21. The method of claim 16, further comprising the step of executing either message transmission or a call when a specific key is pressed in the BGM multi-tasking mode.

22. The method of claim 16, further comprising the step of displaying a menu for controlling a volume of a music file, which is being played, when a specific key is pressed in the BGM multi-tasking mode.
